(19) United States
(12) Patent Application Publication
(10) Pub. No.: US 2015/0070924 A1
(43) Pub. Date: Mar. 12, 2015

(54) PRINTED CIRCUIT BOARD AND VEHICULAR LAMP

(71) Applicant: KOITO MANUFACTURING CO., LTD., Tokyo (JP)

(72) Inventor: Takahiro KADOWAKI, Shizuoka-shi (JP)

(73) Assignee: KOITO MANUFACTURING CO., LTD., Tokyo (JP)

(21) Appl. No.: 14/478,210

(22) Filed: Sep. 5, 2014

(30) Foreign Application Priority Data
Sep. 10, 2013 (JP) 2013-187578

(51) Int. Cl. F21S 8/10

(52) U.S. Cl. CPC F21S 48/115; F21S 48/1388; F21Y 2101/02
USPC 362/517

(57) ABSTRACT

A printed circuit board on which a surface mount device is mounted includes a plurality of lands respectively soldered to a plurality of electrodes of the surface mount device. The plurality of lands includes at least a pair of adjacent lands each of which has a side surface not covered with a solder resist, and the side surfaces not covered with the solder resists are opposite to each other.

### INCORPORATION BY REFERENCE

The disclosure of Japanese Patent Application No. 2013-187578 filed on Sep. 10, 2013 including the specification, drawings and abstract is incorporated herein by reference in its entirety.

### BACKGROUND OF THE INVENTION

1. Field of the Invention

The invention relates to a printed circuit board on which a surface mount device is mounted, and a vehicular lamp including the printed circuit board.

2. Description of Related Art

There is known a vehicular lamp including a plurality of LEDs and a plurality of reflectors that respectively reflect light from the LEDs (see, for example, Japanese Patent Application Publication No. 2011-81975 (JP 2011-81975 A)).

In a vehicular lamp including an LED and a parabolic reflector, when the LED and the reflector have positional relationship as designed, a distribution pattern is formed at a desired position ahead of the vehicle.

The LED is usually mounted on a printed circuit board by soldering the electrodes of the LED on lands formed on the printed circuit board. However, the LED may be moved with respect to the lands while the solder is molten, so there is a possibility that the LED is not mounted at the position as designed. In this case, the positional relationship between the LED and the reflector breaks as designed is not realized, so there is a possibility that the distribution pattern deviates from the desired position.

### SUMMARY OF THE INVENTION

The invention provides a printed circuit board and a vehicular lamp that are able to improve the accuracy of mounting an electronic device onto the printed circuit board.

A first aspect of the invention provides a printed circuit board on which a surface mount device is mounted. The printed circuit board includes a plurality of lands respectively soldered to a plurality of electrodes of the surface mount device. The plurality of lands includes at least a pair of adjacent lands each of which has a side surface not covered with a solder resist, and the side surfaces not covered with the solder resists are opposite to each other.

A shape of at least one of the adjacent lands may be the same as a shape of the electrode that is soldered onto the at least one of the adjacent lands. A size of at least one of the adjacent lands may be smaller than or equal to a size of the electrode that is soldered onto the at least one of the adjacent lands.

A thickness of each land may be larger than or equal to twice as large as a thickness of the solder resist provided on the printed circuit board and smaller than or equal to six times as large as the thickness of the solder resist.

A second aspect of the invention provides a vehicular lamp. The vehicular lamp includes: the printed circuit board according to the first aspect; a light-emitting element mounted on the printed circuit board; and an optical member that is fixed to the printed circuit board and radiates light emitted from the light-emitting element forward.

A plurality of the light-emitting elements may be mounted on the printed circuit board, and the optical member may include a plurality of reflectors each of which reflects light emitted from a corresponding one of the light-emitting elements.

With the above configuration, it is possible to improve the accuracy of mounting an electronic device onto the printed circuit board.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic horizontal cross-sectional view of a vehicular lamp according to an embodiment of the invention;

FIG. 2 is a cross-sectional view of the vehicular lamp, taken along the line II-II in FIG. 1;

FIG. 3 is a view that shows a high-beam distribution pattern that is formed by a high-beam lamp unit;

FIG. 4 is a view that shows a low-beam distribution pattern that is formed by a low-beam lamp unit;

FIG. 5 is a view that shows a device mounting surface of a high-beam circuit board;

FIG. 6 is a view for illustrating an assembled structure of the high-beam circuit board and a high-beam reflector unit;

FIG. 7 is a view that shows the device mounting surface of a printed circuit board and the back surface of an LED;

FIG. 8 is a view that shows the cross-sectional structure of the printed circuit board and the LED;

FIG. 9 is a view that shows a state where the LED is soldered to lands of the printed circuit board; and

FIG. 10A and FIG. 10B are views for illustrating movement of the LED due to solder tension.

### DETAILED DESCRIPTION OF EMBODIMENTS

Hereinafter, a vehicular lamp according to an embodiment of the invention will be described in detail with reference to the accompanying drawings. In the specification, when the terms indicating directions, such as “upper”, “lower”, “front”, “rear”, “right”, “left”, “inner” and “outer”, are used, those mean the directions in position at the time when the vehicular lamp is mounted on a vehicle.

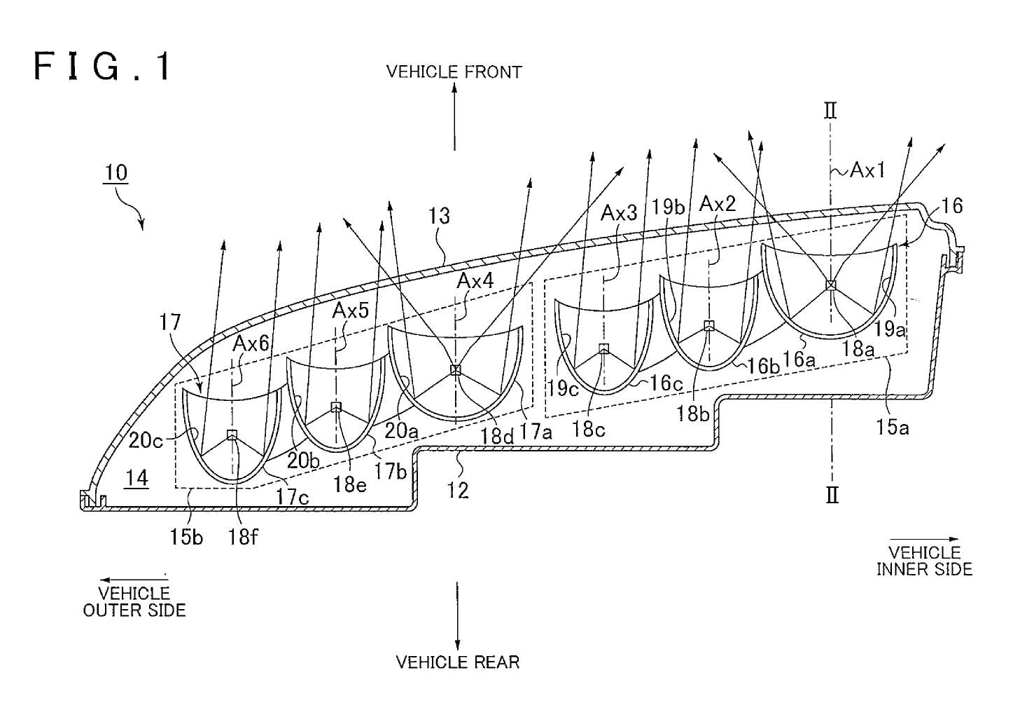

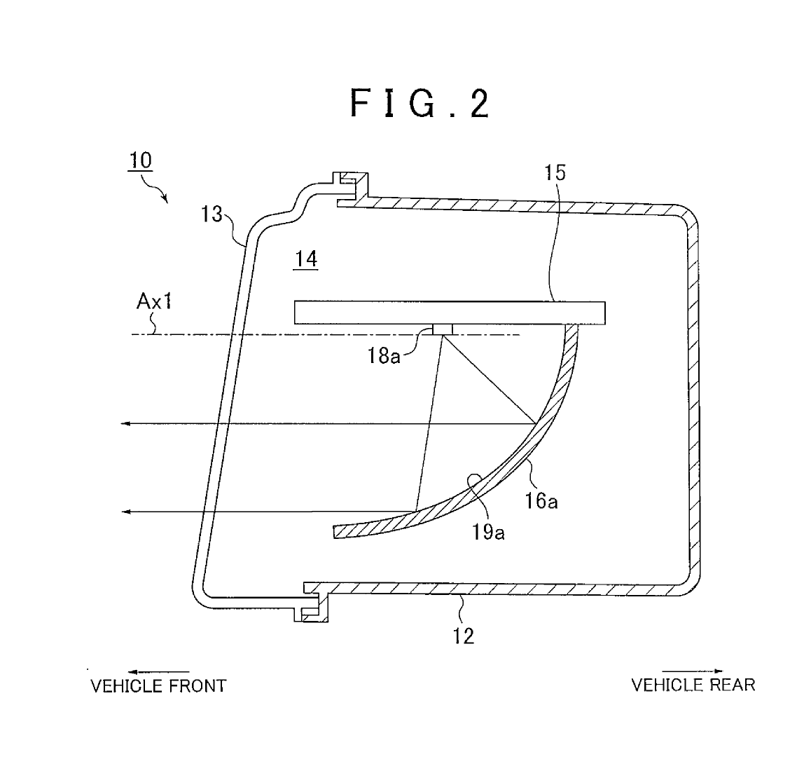

FIG. 1 is a schematic horizontal cross-sectional view of the vehicular lamp 10 according to the embodiment of the invention. FIG. 2 is a cross-sectional view of the vehicular lamp 10, taken along the line II-II in FIG. 1. The vehicular lamp 10 shown in FIG. 1 is a headlamp arranged one by one at each of the right and left sides of the front of the vehicle. The structure of the vehicular lamp 10 is substantially equivalent between the right and left sides, so the structure of the vehicular lamp arranged at the left side of the vehicle will be described.

As shown in FIG. 1 and FIG. 2, the vehicular lamp 10 includes a lamp body 12 and a transparent outer cover 13. The outer cover 13 covers the front opening of the lamp body 12. The lamp body 12 and the outer cover 13 define a lamp chamber 14. As shown in FIG. 1, the outer cover 13 is formed in a shape along a slant nose shape of the vehicle. The outer cover 13 is slanted rearwardly in a direction from the vehicle inner side toward the vehicle outer side. The lamp body 12 is formed in a stepped shape being slanted rearwardly in the direction from the vehicle inner side toward the vehicle outer side according to the shape of the slanted outer cover 13. Thus, the lamp chamber 14 defined by the lamp body 12 and the outer cover 13 is a space slanted rearwardly in the direction from the vehicle inner side toward the vehicle outer side.

A high-beam circuit board 15a, a low-beam circuit board 15b, a high-beam reflector unit 16 and a low-beam reflector unit 17 are accommodated in the lamp chamber 14.

The high-beam circuit board 15a and the low-beam circuit board 15b each are a printed circuit board. The printed circuit board is formed such that a circuit pattern made of copper foil is formed on the surface of a board called substrate. The high-beam circuit board 15a and the low-beam circuit board 15b are arranged side by side at the upper side inside the lamp chamber 14. The high-beam circuit board 15a is arranged on the vehicle inner side, and the low-beam circuit board 15b is arranged on the vehicle outer side. As shown in FIG. 1, the high-beam circuit board 15a and the low-beam circuit board 15b each are formed in a shape slanted rearwardly in the direction from the vehicle inner side toward the vehicle outer side according to the shape of the slanted outer cover 13.

Three LEDs (first LED 18a to third LED 18c) are mounted on the high-beam circuit board 15a such that light-emitting faces of the LEDs are directed downward. These three LEDs are surface mount LEDs. Each of the LEDs has an anode and a cathode on its back surface. The first LED 18a to the third LED 18c each emit light upon reception of current that is supplied from the high-beam circuit board 15a. The first LED 18a to the third LED 18c are LEDs that are used to radiate a high beam, and are provided along the vehicle width direction of the high-beam circuit board 15a. Among these three LEDs, the first LED 18a is provided at the vehicle innermost side, the second LED 18b is provided on the outer side of the first LED 18a, and the third LED 18c is provided on the outer side of the second LED 18b.

Similarly, three LEDs (fourth LED 18d to sixth LED 18f) are mounted on the low-beam circuit board 15b such that light-emitting faces of the LEDs are directed downward. These three LEDs are surface mount LEDs. Each of the LEDs has an anode and a cathode on its back surface. The fourth LED 18d to the sixth LED 18f each emit light upon reception of current that is supplied from the low-beam circuit board 15b. The fourth LED 18d to the sixth LED 18f are LEDs that are used to radiate a low beam, and are provided along the vehicle width direction of the low-beam circuit board 15b. Among these three LEDs, the fourth LED 18d is provided at the vehicle innermost side, the fifth LED 18e is provided on the outer side of the fourth LED 18d, and the sixth LED 18f is provided on the outer side of the fifth LED 18e.

The high-beam reflector unit 16 and the low-beam reflector unit 17 are arranged side by side on the lower side of the high-beam circuit board 15a and the low-beam circuit board 15b in the lamp chamber 14. The high-beam reflector unit 16 is arranged on the vehicle inner side, and the low-beam reflector unit 17 is arranged on the vehicle outer side.

The high-beam reflector unit 16 is a reflector group that is used to radiate a high beam, and includes three parabolic reflectors, that is, a high-beam diffusion reflector 16a, a first high-beam condensing reflector 16b and a second high-beam condensing reflector 16c. These three reflectors are integrally formed. Among these three reflectors, the high-beam diffusion reflector 16a is provided at the vehicle innermost side, the first high-beam condensing reflector 16b is provided on the outer side of the high-beam diffusion reflector 16a, and the second high-beam condensing reflector 16c is provided on the outer side of the first high-beam condensing reflector 16b.

The high-beam diffusion reflector 16a, the first high-beam condensing reflector 16b and the second high-beam condensing reflector 16c respectively have reflecting surfaces 19a to 19c each are formed on the basis of a paraboloid of revolution. The rotation center axis of each paraboloid of revolution coincides with the optical axis of a corresponding one of the reflectors. That is, the high-beam diffusion reflector 16a has a first optical axis Ax1, the first high-beam condensing reflector 16b has a second optical axis Ax2, and the second high-beam condensing reflector 16c has a third optical axis Ax3. The high-beam diffusion reflector 16a, the first high-beam condensing reflector 16b and the second high-beam condensing reflector 16c are arranged such that the first optical axis Ax1, the second optical axis Ax2 and the third optical axis Ax3 are directed in the vehicle longitudinal direction (horizontal direction).

The first LED 18a is arranged at the focal point of the reflecting surface 19a of the high-beam diffusion reflector 16a (located in the first optical axis Ax1) (see FIG. 2). The second LED 18b is arranged at the focal point of the reflecting surface 19b of the first high-beam condensing reflector Mb (located in the second optical axis Ax2). The third LED 18c is arranged at the focal point of the reflecting surface 19c of the second high-beam condensing reflector 16c (located in the third optical axis Ax3). Each reflector reflects light from a corresponding one of the LEDs in a direction parallel to its optical axis.

The low-beam reflector unit 17 is a reflector group that is used to radiate a low beam, and includes three parabolic reflectors, that is, a low-beam diffusion reflector 17a, a first low-beam condensing reflector 17b and a second low-beam condensing reflector 17c. These three reflectors are integrally formed. Among these three reflectors, the low-beam diffusion reflector 17a is provided at the vehicle innermost side, the first low-beam condensing reflector 17b is provided on the outer side of the low-beam diffusion reflector 17a, and the second low-beam condensing reflector 17c is provided on the outer side of the first low-beam condensing reflector 17b.

The low-beam diffusion reflector 17a, the first low-beam condensing reflector 17b and the second low-beam condensing reflector 17c respectively have reflecting surfaces 20a to 20c each formed on the basis of a paraboloid of revolution. The rotation center axis of each paraboloid of revolution coincides with the optical axis of a corresponding one of the reflectors. That is, the low-beam diffusion reflector 17a has a fourth optical axis Ax4, the first low-beam condensing reflector 17b has a fifth optical axis Ax5, and the second low-beam condensing reflector 17c has a sixth optical axis Ax6. The low-beam diffusion reflector 17a, the first low-beam condensing reflector 17b and the second low-beam condensing reflector 17c are arranged such that the fourth optical axis Ax4, the fifth optical axis Ax5 and the sixth optical axis Ax6 are directed in the vehicle longitudinal direction (horizontal direction).

The fourth LED 18d is arranged at the focal point of the reflecting surface 20a of the low-beam diffusion reflector 17a (located in the fourth optical axis Ax4). The fifth LED 18e is arranged at the focal point of the reflecting surface 20b of the first low-beam condensing reflector 17b (located in the fifth optical axis Ax5). The sixth LED 18f is arranged at the focal point of the reflecting surface 20c of the second low-beam condensing reflector 17c (located in the sixth optical axis Ax6). Each reflector reflects light from a corresponding one of the LEDs in a direction parallel to its optical axis.

The high-beam reflector unit 16 and the low-beam reflector unit 17 each are formed by evaporating aluminum onto the inner surface of a resin-molded base member.

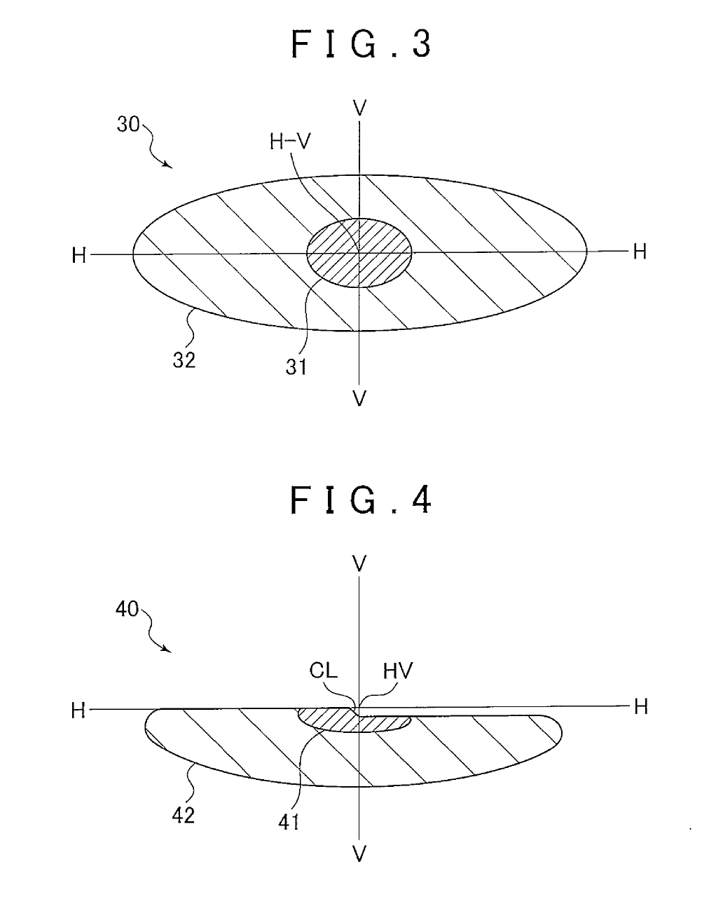

In the present embodiment, the high-beam reflector unit 16 and the first LED 18a to the third LED 18c constitute a high-beam lamp unit that radiates a high beam. FIG. 3 shows a high-beam distribution pattern 30 that is formed by the high-beam lamp unit. The high-beam distribution pattern 30 shown in FIG. 3 is a distribution pattern that is formed on an imaginary vertical screen arranged at a location 25 m ahead of the vehicular lamp 10. FIG. 3 shows a vertical line V-V passing through an H-V point that is a vanishing point in a lamp forward direction, and a horizontal line H-H passing through the H-V point.

A high-beam condensed distribution pattern 31 is formed around the H-V point from light reflected from the reflecting surface 19b of the first high-beam condensing reflector 16b after being emitted from the second LED 18b and light reflected from the reflecting surface 19c of the second high-beam condensing reflector 16c after being emitted from the third LED 18c. The high-beam condensed distribution pattern 31 is a high light intensity region called “hot zone”. A high-beam diffusion distribution pattern 32 is formed from light reflected from the reflecting surface 19a of the high-beam diffusion reflector 16a after being emitted from the first LED 18a so as to cover the high-beam condensed distribution pattern 31. The high-beam diffusion distribution pattern 32 is wider in both the horizontal line H-H direction and the vertical line V-V direction than the high-beam condensed distribution pattern 31. The high-beam condensed distribution pattern 31 may be, for example, a region ranging in the horizontal line H-H direction by about ±10° to 15° and ranging in the vertical line V-V direction by about ±3° to 5°. The high-beam diffusion distribution pattern 32 may be, for example, a region ranging in the horizontal line H-H direction by about ±25° to 35° and ranging in the vertical line V-V direction by about ±8° to 10°. The high-beam distribution pattern 30 is formed by superimposing the high-beam condensed distribution pattern 31 on the high-beam diffusion distribution pattern 32.

The low-beam reflector unit 17 and the fourth LED 18d to the sixth LED 18f constitute a low-beam lamp unit that radiates a low beam. FIG. 4 shows a low-beam distribution pattern 40 that is formed by the low-beam lamp unit. The low-beam distribution pattern is a distribution pattern having a cut-off line in a predetermined shape.

A low-beam condensed distribution pattern 41 is formed around the H-V point from light reflected from the reflecting surface 20b of the first low-beam condensing reflector 17b after being emitted from the fifth LED 18e and light reflected from the reflecting surface 20c of the second low-beam condensing reflector 17c after being emitted from the sixth LED 18f. The low-beam condensed distribution pattern 41 is a high light intensity region called “hot zone”, and has a cut-off line CL in a predetermined shape. A low-beam diffusion distribution pattern 42 is formed from light reflected from the reflecting surface 20a of the low-beam diffusion reflector 17a after being emitted from the fourth LED 18d so as to cover the low-beam condensed distribution pattern 41. The low-beam diffusion distribution pattern 42 is wider in both the horizontal line H-H direction and the vertical line V-V direction than the low-beam condensed distribution pattern 41. The low-beam condensed distribution pattern 41 may be, for example, a region ranging in the horizontal line H-H direction by about ±10° to 15° and ranging in the vertical line V-V direction by about 0° to −5°. The low-beam diffusion distribution pattern 42 may be, for example, a region ranging in the horizontal line H-H direction by about ±25° to 45° and ranging in the vertical line V-V direction by about 0° to −10°. The low-beam distribution pattern 40 is formed by superimposing the low-beam condensed distribution pattern 41 on the low-beam diffusion distribution pattern 42.

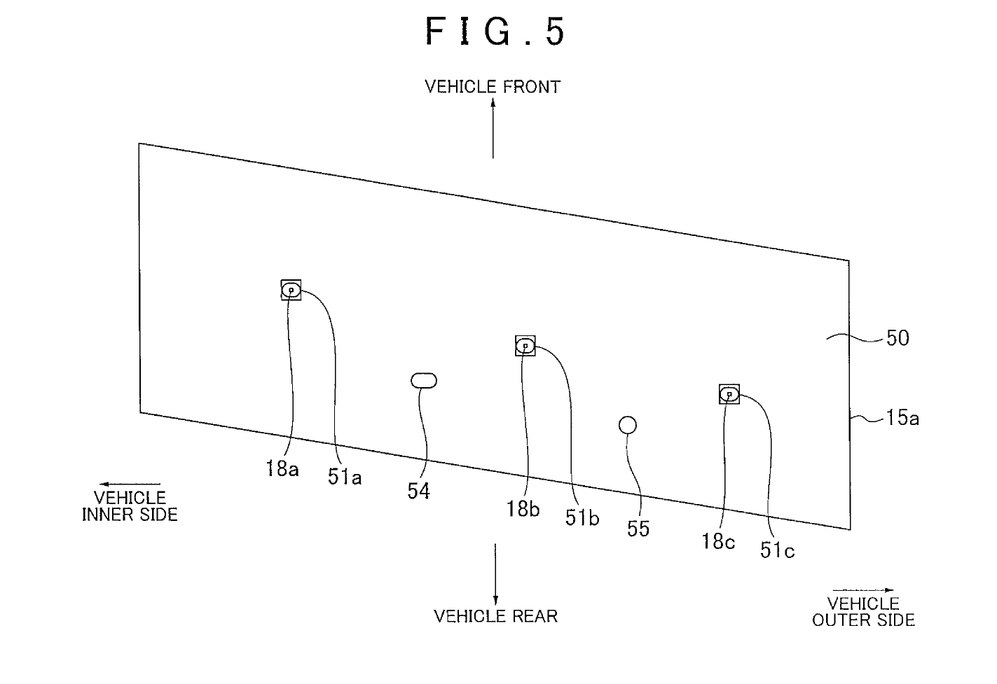

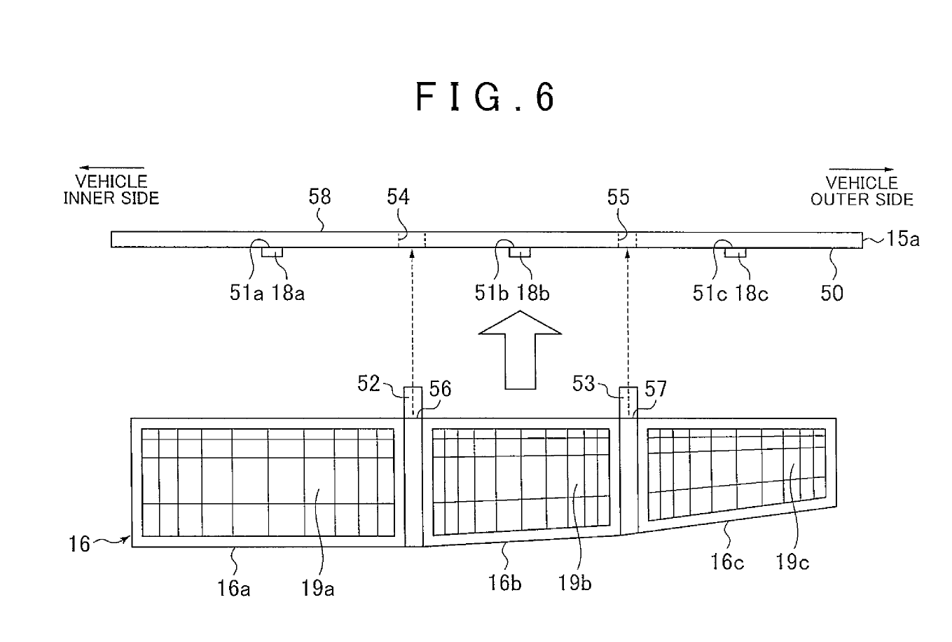

FIG. 5 is a view that shows a device mounting surface 50 of the high-beam circuit board 15a. FIG. 6 is a view for illustrating an assembled structure of the high-beam circuit board 15a and the high-beam reflector unit 16. The device mounting surface 50 shown in FIG. 5 is directed downward in a state of being mounted on the vehicle as shown in FIG. 6.

A first LED mounting portion 51a, a second LED mounting portion 51b and a third LED mounting portion 51c for respectively mounting the first LED 18a, the second LED 18b and the third LED 18c are provided on the device mounting surface 50 of the high-beam circuit board 15a in the vehicle width direction. Each LED mounting portion includes lands for soldering the electrodes of a corresponding one of the LEDs. The structure of each LED mounting portion will be described later.

As shown in FIG. 6, the high-beam reflector unit 16 is mounted on the device mounting surface 50 of the high-beam circuit board 15a. In the present embodiment, the high-beam reflector unit 16 includes a first positioning pin 52 and a second positioning pin 53. The high-beam circuit board 15a has a first positioning hole 54 and a second positioning hole 55. The first positioning hole 54 is provided at a portion corresponding to the first positioning pin 52 to receive the first positioning pin 52. The second positioning hole 55 is provided at a portion corresponding to the second positioning pin 53 to receive the second positioning pin 53. When the positioning pins 52, 53 are respectively inserted to the corresponding positioning holes 54, 55, the high-beam reflector unit 16 is positioned on the device mounting surface 50 of the high-beam circuit board 15a.

The first positioning pin 52 protrudes from a first coupling portion 56. The first coupling portion 56 couples the high-beam diffusion reflector 16a to the first high-beam condensing reflector 16b. The second positioning pin 53 protrudes from a second coupling portion 57. The second coupling portion 57 couples the first high-beam condensing reflector 16b to the second high-beam condensing reflector 16c. The first positioning pin 52 and the second positioning pin 53 each may be a cylindrical columnar pin. The size of the first positioning pin 52 may be equal to the size of the second positioning pin 53. The first positioning pin 52 and the second positioning pin 53 may have a height larger than or equal to the thickness of the high-beam circuit board 15a.

As shown in FIG. 5 and FIG. 6, the first positioning hole 54 is provided at a location inward of the first LED mounting portion 51a located at one end side (vehicle inner side) of the high-beam circuit board 15a in the vehicle width direction, and the second positioning hole 55 is provided at a location inward of the third LED mounting portion 51c located at the other end (vehicle outer side) of the high-beam circuit board 15a in the vehicle width direction. More specifically, the first positioning hole 54 is provided between the first LED mounting portion 51a and the adjacent second LED mounting portion 51b, and the second positioning hole 55 is provided between the third LED mounting portion 51c and the adjacent second LED mounting portion 51b.

In the present embodiment, the first positioning hole 54 is a long hole extending in the vehicle width direction of the circuit board. When the first positioning pin 52 to be inserted into the first positioning hole 54 has a cylindrical shape, the first positioning hole 54 is a long hole of which the inside diameter in the vehicle width direction is larger than the diameter of the first positioning pin 52 and the inside diameter in the vehicle longitudinal direction is substantially equal to the diameter of the first positioning pin 52 in cross section perpendicular to the vertical direction. On the other hand, the second positioning hole 55 has a shape and a size substantially equal to those of the second positioning pin 53 to be inserted into the second positioning hole 55 in cross section perpendicular to the vertical direction. When the second positioning pin 53 has a cylindrical shape, the second positioning hole 55 is a cylindrical hole of which the inside diameter is equal to the diameter of the second positioning pin 53. As in the case of the present embodiment, by forming one of the two positioning holes in an long hole, it is possible to allow the tolerance of the high-beam reflector unit 16.

When the high-beam reflector unit 16 is assembled to the high-beam circuit board 15a, the first positioning pin 52 and second positioning pin 53 of the high-beam reflector unit 16 are respectively inserted into the first positioning hole 54 and second positioning hole 55 of the high-beam circuit board 15a, as shown in FIG. 6. After that, portions of the first positioning pin 52 and second positioning pin 53, protruded from a back surface 58 across from the device mounting surface 50, are subjected to thermal caulking. Thus, the high-beam reflector unit 16 is fixed to the high-beam circuit board 15a. In the present embodiment, the first positioning pin 52 and the second positioning pin 53 serve to both position and fix the high-beam reflector unit 16 to the high-beam circuit board 15a. Instead, the first positioning pin 52 and the second positioning pin 53 may be used only for positioning, and another member may be used for fixing. For example, screw fixing holes may be respectively provided in the high-beam circuit board 15a and the high-beam reflector unit 16, and the high-beam reflector unit 16 may be fixed to the high-beam circuit board 15a by screws.

In the above-described embodiment, the second positioning hole 55 formed in a shape and a size substantially equal to those of the second positioning pin 53 is provided at a portion closer to the second LED mounting portion 51b and the third LED mounting portion 51c on which the condensing second LED 18b and third LED 18c are mounted than the first LED mounting portion 51a on which the diffusing first LED 18a is mounted, as shown in FIG. 5 and FIG. 6. This is because the condensing second LED 18b and third LED 18c require higher positional accuracy than the diffusing first LED 18a. With such a configuration, it is possible to improve the light distribution performance of the vehicular lamp 10.

In the above description, the assembled structure of the high-beam circuit board 15a and the high-beam reflector unit 16 is mainly described; however, this is similar to the assembled structure of the low-beam circuit board 15b and the low-beam reflector unit 17.

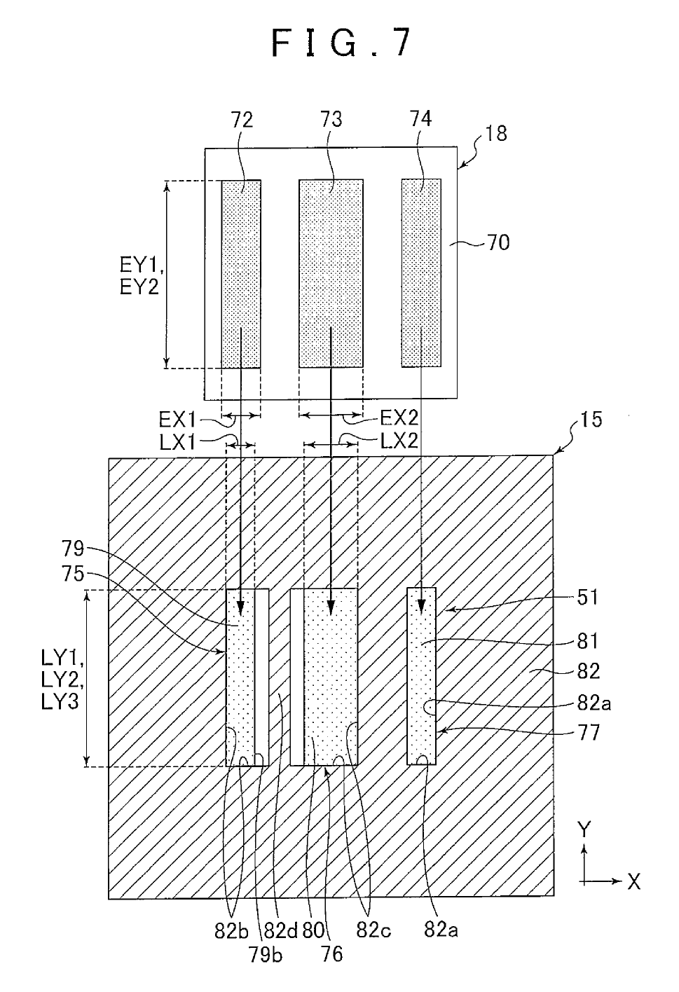

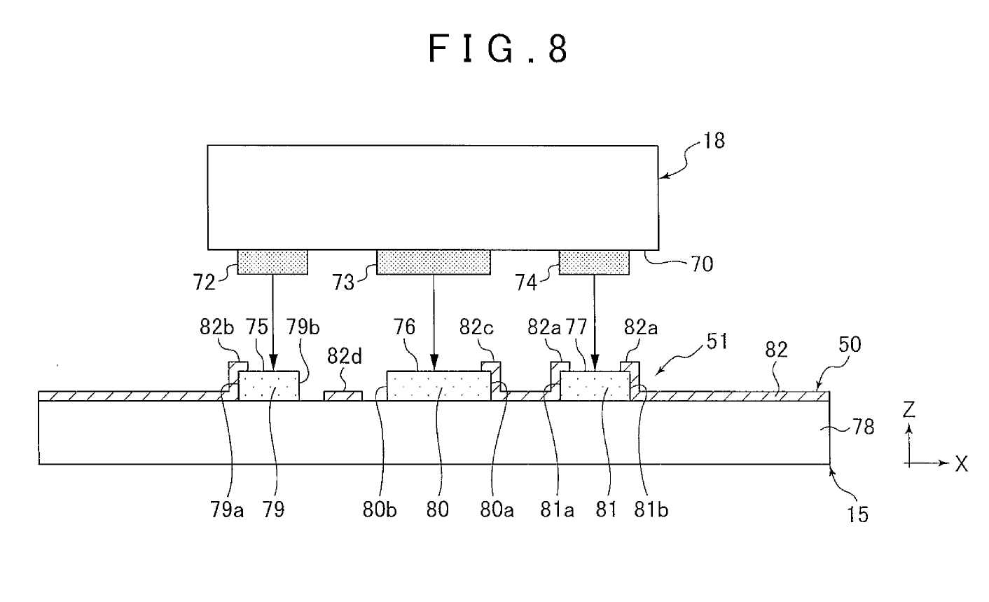

Next, the mounting structure of the LEDs in the vehicular lamp 10 according to the present embodiment will be described. FIG. 7 shows the device mounting surface 50 of the printed circuit board 15 and a back surface 70 of each LED 18. FIG. 8 shows the cross-sectional structure of the printed circuit board 15 and LED 18.

The LED 18 shown in FIG. 7 and FIG. 8 is a surface mount LED. Three electrodes, that is, an anode 72, a first cathode 73 and a second cathode 74, are provided on the back surface 70 of the LED 18. The anode 72 is arranged at the left end of the back surface 70 in the X direction. The first cathode 73 is arranged at the center of the back surface 70 in the X direction. The second cathode 74 is arranged at the right end of the back surface 70 in the X direction. In the present embodiment, the first cathode 73 and the second cathode 74 are provided as separate electrodes; however, the first cathode 73, and the second cathode 74 are electrically continuous with each other inside the LED. The anode 72, the first cathode 73 and the second cathode 74 each are formed in a rectangular shape in plain view.

The LED mounting portion 51 for mounting the LED 18 is provided on the device mounting surface 50 of the printed circuit board 15. The LED mounting portion 51 includes three lands, that is, an anode land 75, a first cathode land 76 and a second cathode land 77. The anode land 75 is arranged at the left end of the LED mounting portion 51 in the X direction, and is soldered to the anode 72 of the LED 18. The first cathode land 76 is arranged at the center of the LED mounting portion 51 in the X direction, and is soldered to the first cathode 73 of the LED 18. The second cathode land 77 is arranged at the right end of the LED mounting portion 51 in the X direction, and is soldered to the second cathode 74 of the LED 18.

Each of the lands of the LED mounting portion 51 has a corresponding one of conductor patterns 79, 80, 81 and a solder resist 82. Each of the conductor patterns 79, 80, 81 is provided on a substrate 78, such as glass-cloth epoxy resin. In the present embodiment, the shape of each land is defined by two types of methods. The first method is to define each land shape by printing the solder resist on the conductor pattern. The second method is to define each land shape by exposing an etched surface of the conductor pattern.

This will be specifically described with reference to FIG. 7 and FIG. 8. The land shape of the second cathode land 77 is defined by covering all around the conductor pattern 81, provided on the substrate 78, with a solder resist 82a. All the side surfaces of the conductor pattern 81, that is, both the side surfaces of the conductor pattern 81 in the Y direction, the left side surface 81a of the conductor pattern 81 in the X direction and the right side surface 81b of the conductor pattern 81 in the X direction, are covered with the solder resist 82a. In the following description, the side surface of the conductor pattern, covered with the solder resist, is termed “resist side surface”. The land shape of the second cathode land 77 is the shape of a region surrounded by the resist side surfaces.

On the other hand, in the anode land 75, part of the side surfaces of the conductor pattern 79 is not covered with a solder resist. That is, both side surfaces of the conductor pattern 79 in the Y direction and the left side surface 79a of the conductor pattern 79 in the X direction are covered with the solder resist 82b; however, the right side surface 79b of the conductor pattern 79 in the X direction is not covered with a solder resist. That is, the right side surface 79b of the conductor pattern 79 formed by etching is exposed. In the following description, the side surface of the conductor pattern, not covered with a solder resist, is termed “non-resist side surface”. In the anode land 75, the shape of a region surrounded by the resist side surfaces and the non-resist side surface is the land shape.

Similarly, in the first cathode land 76 as well, part of the side surfaces of the conductor pattern 80 is not covered with a solder resist. That is, both side surfaces of the conductor pattern 80 in the Y direction and the right side surface 80a of the conductor pattern 80 in the X direction are covered with the solder resist 82c; however, the left side surface 80b of the conductor pattern 80 in the X direction is not covered with a solder resist. That is, the left side surface 80b of the conductor pattern 80 formed by etching is exposed. In the first cathode land 76 as well, the shape of a region surrounded by the resist side surfaces and the non-resist side surface is the land shape.

In the present embodiment, the LED mounting portion 51 includes three lands as described above. The adjacent anode land 75 and first cathode land 76 among the three lands are provided such that the non-resist side surfaces are opposite (adjacent) to each other. That is, the right side surface 79b as the non-resist side surface of the anode land 75, is opposite to the left side surface 80b as the non-resist side surface of the first cathode land 76.

A solder resist region 82d is provided on the substrate 78 between the adjacent anode land 75 and first cathode land 76. The solder resist region 82d is provided in order to prevent flow of solder between the anode land 75 and the first cathode land 76.

In the present embodiment, the anode land 75 and the first cathode land 76 are respectively formed in the same shapes as the electrodes that are soldered on the anode land 75 and the first cathode land 76. That is, the anode land 75 and the first cathode land 76 respectively have the same rectangular shapes as the anode 72 and the first cathode 73. In the present embodiment, the second cathode land 77 also has the same rectangular shape as the second cathode 74 that is soldered on the second cathode land 77; however, this is not specifically limited.

In the present embodiment, the anode land 75 and the first cathode land 76 respectively has sizes smaller than or equal to the sizes of the electrodes that are soldered on the anode land 75 and the first cathode land 76. That is, the width LX1 of the anode land 75 in the X direction and the width LY1 of the anode land 75 in the Y direction are respectively smaller than or equal to the width EX1 of the anode 72 in the X direction and the width EY1 of the anode 72 in the Y direction. The width LX2 of the first cathode land 76 in the X direction and the width LY2 of the first cathode land 76 in the Y direction are respectively smaller than or equal to the width EX2 of the first cathode 73 in the X direction and the width EY2 of the first cathode 73 in the Y direction. In the present embodiment, the second cathode land 77 is also smaller than or equal to the second cathode 74 that is soldered on the second cathode land 77; however, this is not specifically limited.

In the present embodiment, each land is thicker than the solder resist 82 provided on the substrate 78. The thickness TL of each land is desirably larger than or equal to twice as large as the thickness TR of the solder resist 82 provided on the substrate 78 and smaller than or equal to six times as large as the thickness TR. For example, when the solder resist thickness TR is 20 μm, the land thickness TL is desirably 40 μm to 120 μm.

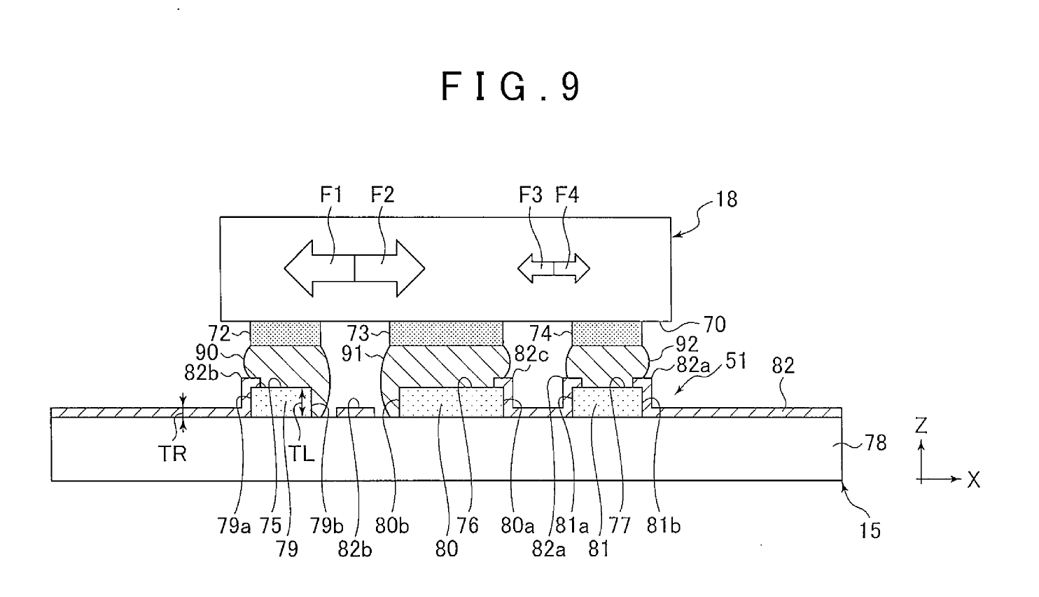

FIG. 9 shows a state where the LED 18 is soldered to the lands of the printed circuit board 15. As shown in FIG. 9, a solder portion 90 is provided between the anode 72 and the anode land 75, a solder portion 91 is provided between the first cathode 73 and the first cathode land 76, and a solder portion 92 is provided between the second cathode 74 and the second cathode land 77. In FIG. 9, the solder portions 90, 91, 92 are molten.

While solder is molten, there occurs the tension of solder, and the tension of the solder may move the LED 18 mounted on the printed circuit board 15. FIG. 9 shows a solder tension F1 that acts on the LED 18 from the right-side portion of the solder portion 90, a solder tension F2 that acts on the LED 18 from the left-side portion of the solder portion 91, a solder tension F3 that acts on the LED 18 from the right-side portion of the solder portion 91, and a solder tension F4 that acts on the LED 18 from the left-side portion of the solder portion 92. The solder tensions F1 to F4 are forces that act in the X direction. As shown in FIG. 9, the solder tensions F1, F2 equally act in opposite directions. The solder tensions F3, F4 equally act in opposite directions.

As shown in FIG. 9, because the right side surface 79b of the anode 72 and the left side surface 80b of the first cathode 73 are non-resist surfaces, solder covers those side surfaces. On the other hand, the right side surface 80a of the first cathode land 76 and the left side surface 81a of the second cathode land 77 are resist surfaces, so no solder covers those side surfaces. In the present embodiment, each land is thicker than the solder resist 82 provided on the substrate 78. Therefore, the amount of solder per unit area at the right-side portion of the solder portion 90 or the left-side portion of the solder portion 91 is larger than the amount of solder per unit area at the right-side portion of the solder portion 91 or the left-side portion of the solder portion 92. As a result, the solder tensions F1, F2 are larger than the solder tensions F3, F4. This means that the solder tensions F1, F2 have larger forces in moving the LED 18 than those of the solder tensions F3, F4, so the solder tensions F1, F2 are more predominant in force moving the LED 18 than the solder tensions F3, F4.

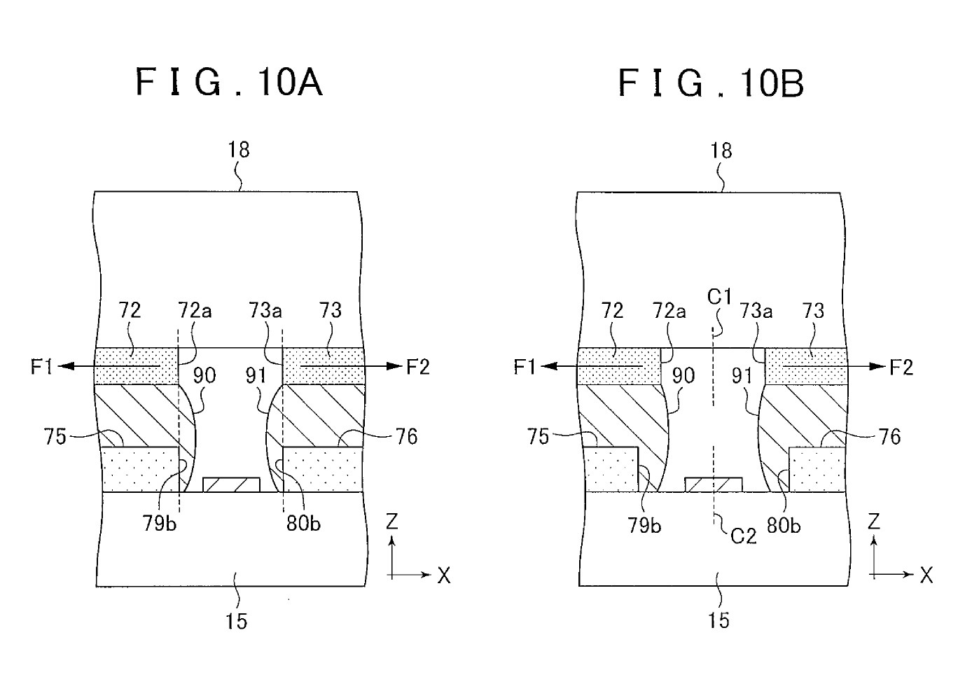

FIG. 10A and FIG. 10B are views for illustrating movement of the LED 18 in the X direction due to solder tension.

FIG. 10A shows the way of movement of the LED 18 in the X direction in the case where the sizes of the anode land 75 and first cathode land 76 are respectively equal to the sizes of the anode 72 and first cathode 73 are soldered on the anode land 75 and the first cathode land 76. In this case, as shown in FIG. 10A, due to the solder tensions F1, F2, the LED 18 moves in the X direction such that the right side surface 72a of the anode 72 and the right side surface 79b of the anode land 75 overlap with each other and the left side surface 73a of the first cathode 73 and the left side surface 80b of the first cathode land 76 overlap with each other.

FIG. 10B shows the way of movement of the LED 18 in the X direction in the case where the sizes of the anode land 75 and first cathode land 76 are respectively smaller than the sizes of the anode 72 and first cathode 73 that are soldered on the anode land 75 and the first cathode land 76. In this case, as shown in FIG. 10B, due to the solder tensions F1, F2, the LED 18 moves in the X direction such that a center C1 between the right side surface 72a of the anode 72 and the opposite left side surface 73a of the first cathode 73 matches with a center C2 between the right side surface 79b of the anode land 75 and the opposite left side surface 80b of the first cathode land 76. In this way, in any of the cases shown in FIG. 10A and FIG. 10B, the LED 18 is positioned to the predetermined position in the X direction with respect to the printed circuit board 15.

In this way, according to the present embodiment, by providing the anode land 75 and the first cathode land 76 such that the non-resist faces are opposite to each other, tensions of the solder portions provided on these lands are predominant in movement of the LED 18. The shapes of the anode land 75 and first cathode land 76 of which the non-resist faces are opposite are respectively the same as the shapes of the anode 72 and first cathode 73 that are soldered on the anode land 75 and the first cathode land 76, and the sizes of the anode land 75 and first cathode land 76 are respectively smaller than or equal to the sizes of the anode 72 and first cathode 73. Thus, the LED 18 is positioned to the predetermined position in the X direction with respect to the lands of the printed circuit board 15, so it is possible to mount the LED 18 at the position of the printed circuit board 15 in the X direction as designed.

Improvement in mounting accuracy of the LED 18 in the X direction is described above, and the mounting accuracy in the Y direction also improves according to the present embodiment. As described above, in the present embodiment, the shapes of the anode land 75 and first cathode land 76 are respectively the same as the shapes of the anode 72 and first cathode 73 that are soldered on the anode land 75 and the first cathode land 76, so the side surfaces of the lands and the side surfaces of the electrodes are parallel to each other at both ends in the Y direction. Thus, the solder tension acts in the direction in which the midpoint of each electrode in the Y direction coincides with the midpoint of the corresponding land in the Y direction, so it is also possible to improve the mounting accuracy of the LED 18 in the Y direction. That is, according to the present embodiment, it is possible to improve the mounting accuracy in the X direction and in the Y direction.

By applying the LED mounting structure described in FIG. 7 to FIG. 10B to the vehicular lamp 10 shown in FIG. 1, it is possible to mount the LEDs and the reflectors in the positional relationship as designed, so it is possible to prevent or at least suppress a positional deviation of the distribution pattern.

As in the case of the vehicular lamp 10 shown in FIG. 1, when a plurality of reflectors are integrally formed or when a plurality of LEDs are mounted on a common single circuit board, it is difficult to set the direction of a light beam emitted from each reflector to an ideal direction by adjusting the orientation of each reflector. If the mounting positions of part or all of the LEDs deviate from predetermined positions, the distribution pattern around the H-V point, which should be particularly set to a high light intensity, becomes dark, so there is a concern that distance visibility decreases. In a low-beam lamp unit, a deviation of the mounting positions of the LEDs leads to a deformation of the shape of the cut-off line, with the result that there is a concern that a driver of a host vehicle experiences a feeling of strangeness or a driver of an oncoming vehicle feels too bright. In this respect, with the vehicular lamp 10 in which the LED mounting structure described in FIG. 7 to FIG. 10B is applied, it is possible to suppress a positional deviation of the distribution pattern, so it is possible to prevent these inconveniences.

In the above-described embodiment, the adjacent anode land 75 and first cathode land 76 respectively have the same shapes as the electrodes that are soldered on the anode land 75 and the first cathode land 76; however, the shape of at least one of the adjacent two lands just needs to have the same shape as the corresponding one of the electrodes, which is soldered on the at least one of the adjacent two lands. In the above-described embodiment, the sizes of the adjacent anode land 75 and first cathode land 76 are respectively smaller than the sizes of the electrodes that are soldered on the anode land 75 and the first cathode land 76; however, the size of at least one of the adjacent two lands just needs to be smaller than the size of a corresponding one of the electrodes, which is soldered on the at least one of the adjacent two lands.

The invention is described on the basis of the embodiments. These embodiments are only illustrative, and various alternative embodiments are applicable in combinations of the component elements or processes, and the invention also encompasses those alternative embodiments.

For example, in the above-described embodiment, the surface mount LEDs are illustrated as electronic devices (surface mount devices) mounted on the printed circuit board. the printed circuit board according to the embodiment of the invention does not limit the surface mount LEDs, and may be applied to any surface mount devices.

In the above-described embodiment, the reflectors are illustrated as optical members that radiate light emitted from the LEDs forward; however, the optical members are not limited to the reflectors, and may be, for example, projection lenses.

What is claimed is:

1. A printed circuit board on which a surface mount device is mounted, the printed circuit board comprising:
a plurality of lands respectively soldered to a plurality of electrodes of the surface mount device, the plurality of lands including at least a pair of adjacent lands each of which has a side surface not covered with a solder resist, the side surfaces not covered with the solder resists being opposite to each other.

2. The printed circuit board according to claim 1, wherein a shape of at least one of the adjacent lands is the same as a shape of the electrode that is soldered onto the at least one of the adjacent lands.

3. The printed circuit board according to claim 1, wherein a size of at least one of the adjacent lands is smaller than or equal to a size of the electrode that is soldered onto the at least one of the adjacent lands.

4. The printed circuit board according to claim 1, wherein a thickness of each land is larger than or equal to twice as large as a thickness of the solder resist provided on the printed circuit board and smaller than or equal to six times as large as the thickness of the solder resist.

5. A vehicular lamp comprising:
the printed circuit board according to claim 1;
a light-emitting element mounted on the printed circuit board; and
an optical member that is fixed to the printed circuit board and radiates light emitted from the light-emitting element forward.

6. The vehicular lamp according to claim 5, wherein:
a plurality of the light-emitting elements are mounted on the printed circuit board; and
the optical member includes a plurality of reflectors each of which reflects light emitted from a corresponding one of the light-emitting elements.
